(19) United States
(12) Patent Application Publication
(10) Pub. No.: US 2026/0308378 A1
(43) Pub. Date: Oct. 8, 2026

(54) CURABLE COMPOSITION

(71) Applicant: Wacker Chemie AG, Munich (DE)

(72) Inventors: Ufuk Karabiyik, Ann Arbor, MI (US); Aaron Bush, Ann Arbor, MI (US); Rabih Makki, Silverspring, MD (US); Nicholas White, Ann Arbor, MI (US)

(73) Assignee: Wacker Chemie AG, Munich (DE)

(21) Appl. No.: 19/485,287

(22) PCT Filed: May 25, 2023
(86) PCT No.: PCT/EP2023/064069

§ 371 Date: Nov. 18, 2025

(51) Int. Cl. C08L 83/04; C08G 77/44; C08K 3/105; C08K 3/30; C08K 3/36; C08K 5/053

(52) U.S. Cl. CPC C08L 83/04; C08G 77/44; C08K 3/105; C08K 3/36; C08K 5/053; C08G 2170/00; C08K 2003/3045; C08L 2205/025; C08L 2205/05

(57) ABSTRACT

A curable composition includes a first organopolysiloxane compound having one or more groups comprising a silicon atom bonded to a hydrogen atom and a second organopolysiloxane compound having one or more groups comprising a carbon-carbon multiple bond. The curable composition also includes a hydrosilyation catalyst, an organopolysiloxane resin, a silver-containing antimicrobial agent, and a hydrophillic compound. The composition is an emulsion that has a continuous phase and a discontinuous phase. The silver-containing antimicrobial agent and the hydrophillic compound are present in the discontinuous phase.

### BACKGROUND

The invention relates to a curable composition and uses of the same.

Wound care dressings often contain an adhesive layer that includes a silver containing compound and/or other antimicrobial agents to help prevent infections and promote wound healing. Such adhesive layers may be formed by applying a composition to a substrate and allowing the composition to cure.

In order to enhance the delivery of the antimicrobial agent(s) from the cured composition, an additive may be included. Such additives may be utilized to swell the cured composition during use and enable the antimicrobial agent(s) to flow more freely out of the adhesive layer. However, such additives are often incompatible with the other components of the composition and phase separation may be observed in the composition prior to curing. Precuring phase separation is not desirable because it can lead to an adhesive layer that is not homogenous and/or a reduction in the tack exhibited by the adhesive layer.

Therefore, it would be desirable to provide a composition that can overcome the aforementioned deficiencies.

### BRIEF SUMMARY

Embodiments of a curable composition are provided.

In an embodiment, the curable composition comprises a first organopolysiloxane compound having one or more groups comprising a silicon atom bonded to a hydrogen atom, a second organopolysiloxane compound having one or more groups comprising a carbon-carbon multiple bond, a hydrosilyation catalyst, an organopolysiloxane resin, a silver-containing antimicrobial agent, and a hydrophillic compound. The composition is an emulsion that has a continuous phase and a discontinuous phase. The antimicrobial agent and the hydrophilic compound are present in the discontinuous phase.

In other embodiments, the composition comprises 0.5 wt % or more of the organopolysiloxane resin, based on the total weight of the composition. In one such embodiment, the composition comprises 0.5 to 5 wt % of the organopolysiloxane resin, based on the total weight of the composition.

In some embodiments, the organopolysiloxane resin comprises M and Q units.

In further embodiments, the curable composition does not exhibit an observable phase separation for at least 24 hours at 23° C. and a relative humidity of 55% or after being centrifuged at 23° C. and 5000 rpm for 5 minutes. In another such embodiment, the curable composition does not exhibit an observable phase separation after 90 days at 23° C. and a relative humidity of 55% or after being centrifuged at 23° C. and 5000 rpm for 5 minutes.

Preferably, an interfacial tension between the continuous phase and the discontinuous phase is less than 28 mN/m. In certain embodiments, the interfacial tension between the continuous phase and the discontinuous phase is 22 to 28 mN/m.

In an embodiment, the silver-containing antimicrobial agent is silver salt.

In further embodiments, the hydrophilic compound is a polyol. In one embodiment, the polyol is glycerol. In another embodiment, the hydrophillic compound is polyhydric alcohol or a polyether.

In certain embodiments, the curable composition has a continuous phase comprising an polysiloxane network.

In other embodiments, the curable composition comprises a hydrosilylation inhibitor.

In some embodiments, the antimicrobial agent and the hydrophillic compound are present in the discontinuous phase.

In other embodiments, a method of forming a gel adhesive is provided. In one embodiment, the method comprises applying the curable composition to a substrate and curing the composition.

### BRIEF DESCRIPTION OF THE SEVERAL VIEWS OF THE DRAWING

The above, as well as other advantages of the present invention will become readily apparent to those skilled in the art from the following detailed description when considered in the light of the accompanying drawings in which:

FIG. 1 is a graph illustrating the interfacial tension between the continuous phase and discontinuous phase of embodiments of the curable composition of the present invention.

### DETAILED DESCRIPTION

It is to be understood that the invention may assume various alternative orientations and step sequences, except where expressly specified to the contrary. It is also to be understood that the specific materials, compositions, articles, and methods described in the following specification are simply exemplary embodiments of the inventive concepts. Hence, specific properties, conditions, or other physical characteristics relating to the embodiments disclosed are not to be considered as limiting, unless expressly stated otherwise.

In certain embodiments, a curable composition is provided. The curable composition is suitable for use in wound care dressings. For example, the composition may be utilized to provide an adhesive portion for the wound care dressing. However, the curable composition is not limited to wound care applications and can be utilized in other applications where inhibiting the growth of microbes is desired. Such applications may be of the medical or non-medical variety.

The curable composition comprises a first organopolysiloxane compound. The first organopolysiloxane compound has one or more groups comprising a silicon atom bonded to a hydrogen atom. A silicon atom bonded to a hydrogen atom may also be referred to herein as Si-bonded hydrogen or by using the designation “SiH.” In some embodiments, at least one of the one or more groups comprising a silicon atom bonded to a hydrogen atom is a terminal group. In other embodiments, at least one of the one or more groups comprising a silicon atom bonded to a hydrogen atom is a pendant group. In still other embodiments, the first organopolysiloxane compound has two or more groups comprising a silicon atom bonded to a hydrogen atom and at least one group of the two or more groups is a terminal group and at least one group of the two or more groups is a pendant group.

Preferably, the first organopolysiloxane compound has two or more Si-bonded hydrogen atoms, is linear, cyclic, or branched, and composed of units of the general formula (I)

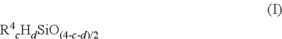

where
R⁴ independently at each occurrence, is a radical free from aliphatic carbon-carbon multiple bonds,
c is 0, 1, 2, or 3, and
d is 0, 1, or 2,
   with the proviso that the sum of c+d is less than or equal to 3 and there are at least two Si-bonded hydrogen atoms per molecule.

In some embodiments, R⁴ may comprise one or more monovalent or polyvalent radicals, in which case the polyvalent radicals, such as divalent, trivalent, and tetravalent radicals, for example, join two or more, such as two, three, or four, for instance, siloxy units of the formula (I) to one another.

In other embodiments, R⁴ may be a monovalent radical of the group comprising F, —Cl, —Br, OR⁶, —CN, —SCN, —NCO, and SiC-bonded, substituted, or unsubstituted hydrocarbon radicals which may be interrupted by oxygen atoms or by the group —C(O)—, and also divalent radicals Si-bonded on both sides in accordance with formula (I). If R⁴ comprises SiC-bonded, substituted hydrocarbon radicals, preferred substituents include halogen atoms, phosphorus-containing radicals, cyano radicals, —OR⁶, —NR⁶—, —NR⁶₂, —NR⁶—C(O)—NR⁶₂, —C(O)—NR⁶₂, —C(O)R⁶, —C(O)OR⁶, —SO₂—Ph, and —C₆F₅. In such embodiments, R⁶, independently at each occurrence, identically or differently, denotes a hydrogen atom or a monovalent hydrocarbon radical having 1 to 20 carbon atoms, and Ph is the phenyl radical.

Further embodiments of R⁴ include alkyl radicals, such as the methyl, ethyl, n propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl, and methylcyclohexyl radicals, aryl radicals, such as the phenyl, naphthyl, anthryl, and phenanthryl radical, alkaryl radicals, such as o-, m-, p-tolyl radicals, xylyl radicals, and ethylphenyl radicals, and aralkyl radicals, such as the benzyl radical, the α- and the β-phenylethyl radical.

When R⁴ is a substituted radical, suitable examples include haloalkyl radicals, such as the 3,3,3-trifluoro-n-propyl radical, the 2,2,2,2′,2′,2′-hexafluoroisopropyl radical, the heptafluoroisopropyl radical, haloaryl radicals, such as the o-, m-, and p chlorophenyl radical, —(CH₂)—N(R⁶)C(O)NR⁶₂, —(CH₂)—C(O)NR⁶₂, —(CH₂)—C(O) R⁶, —(CH₂)ₒ—C(O)OR⁶, —(CH₂)ₒ—C(O)NR⁶₂, —(CH₂)—C(O)—(CH₂)ₚC(O)CH₃, —(CH₂)—O—CO—R⁶, —(CH₂)—NR⁶—(CH₂)ₚ—NR⁶₂, —(CH₂)ₒ—O—(CH₂)ₚCH(OH)CH₂OH, —(CH₂)ₒ(OCH₂CH₂)ₚOR⁶, —(CH₂)ₒ—SO₂—Ph, and —(CH₂)ₒ—O—C₆F₅, where R⁶ and Ph correspond to the definition indicated therefor above, and o and p are identical or different integers between 0 and 10.

Examples of R⁴ as divalent radicals, where is Si-bonded on both sides in accordance with formula (I), are radicals which derive from the monovalent examples stated above for R⁴ by virtue of an additional bond taking place through substitution of a hydrogen atom; examples of such radicals are —(CH₂)—, —CH(CH₃)—, —C(CH₃)₂—, —CH(CH₃)—CH₂—, —C₆H₄—, —CH(Ph)—CH₂—, —C(CF₃)₂—, —(CH₂)ₒ—C₆H₄—(CH₂)ₒ—, —(CH₂)ₒ—C₆H₄—C₆H₄—(CH₂)ₒ—, —(CH₂O)ₚ, (CH₂CH₂O), —(CH₂)ₒ—Oₓ—C₆H₄—SO₂—C₆H₄—Oₓ—(CH₂)—, where x is 0 or 1, and Ph, o, and p have the definition stated above.

Preferably, R⁴ comprises a monovalent, SiC-bonded, optionally substituted hydrocarbon radical which has 1 to 18 carbon atoms and is free from aliphatic carbon carbon multiple bonds, more preferably a monovalent, SiC-bonded hydrocarbon radical which has 1 to 6 carbon atoms and is free from aliphatic carbon-carbon multiple bonds, and more particularly the methyl or phenyl radical.

In certain embodiments, the first organopolysiloxane compound preferably contains Si-bonded hydrogen in a range from 0.04 to 1.7 percent by weight (wt %), based on the total weight of the first organopolysiloxane compound.

The molecular weight of the first organopolysiloxane compound may likewise vary within wide limits, as for instance between 102 and 106 g/mol. Thus, the first organopolysiloxane compound may be, for example, an SiH-functional oligosiloxane of relatively low molecular mass, such as tetramethyldisiloxane, or alternatively may be a silicone resin having SiH groups or a high-polymeric polydimethylsiloxane that possesses SiH groups within the chain or terminally.

In some embodiments, the first organopolysiloxane compound may be provided as all or a portion of a component (A). In certain embodiments, component (A) may comprise a mixture of organopolysiloxanes including one or more embodiments of the first organopolysiloxane compound described above. For example, in an embodiment, component (A) may comprise a mixture of organopolysiloxanes and the mixture may comprise an organopolysiloxane having at least one terminal group comprising a silicon atom bonded to a hydrogen atom and an organopolysiloxane having at least one pendant group comprising a silicon atom bonded to a hydrogen atom. Additional organopolysiloxanes may also be suitable for use in component (A).

As noted above, component (A) may contain a mixture of molecules including two or more distinct organopolysiloxanes. Particularly preferred is the use of low molecular mass, SiH-functional compounds such as tetrakis(dimethylsiloxy) silane and tetramethylcyclotetrasiloxane, and also of SiH-containing siloxanes of higher molecular mass, such as poly(hydrogenmethyl) siloxane and poly(dimethylhydrogenmethyl) siloxane with a viscosity at 25° C. of 10 to 20 000 mPa·s, or similar SiH-containing compounds in which some of the methyl groups have been replaced by 3,3,3-trifluoropropyl or phenyl groups.

The structure of the molecules included in component (A) is also not fixed; in particular, the structure of a SiH-containing organopolysiloxane of relatively high molecular mass, in other words oligomeric or polymeric, may be linear, cyclic, branched, or else resinous, network-like. Linear and cyclic organopolysiloxanes are composed preferably of units of the formula R⁴₃SiO_{1/2}, HR⁴₂SiO_{1/2}, HR⁴SiO_{2/2}, and R⁴₂SiO_{2/2}, with R⁴ having the definition indicated above. Branched and network-like organopolysiloxanes additionally include trifunctional and/or tetrafunctional units, with preference being given to those of the formulae R⁴SiO_{3/2}, HSiO_{3/2}, and SiO_{4/2}, where R⁴ has the definition indicated above.

The amount of component (A) in the curable composition is preferably such that the molar ratio of SiH groups to aliphatically unsaturated groups in the composition is 0.1 to 20, more preferably between 0.3 and 2.0.

The curable composition comprises a second organopolysiloxane compound. The second organopolysiloxane compound has one or more groups comprising a carbon carbon multiple bond. The second organopolysiloxane compound may be provided as a portion of a component (B). In these embodiments, the curable composition may be formed by providing a component (B). Component (B) may comprise the second organopolysiloxane compound or another compound.

In some embodiments, the second organopolysiloxane compound may be a linear organopolysiloxane. In these embodiments, the second organopolysiloxane compound may have one or more terminal groups comprising a carbon-carbon multiple bond, which may also be referred to herein as an aliphatic multiple bond. In one such embodiment, the second organopolysiloxane compound may comprise an SiC-bonded radical having an aliphatic carbon-carbon multiple bond, which may be referred to herein as an aliphatically unsaturated radical. When component (B) comprises another linear compound, such a compound may comprise aliphatic carbon-carbon multiple bonds.

As noted above, component (B) may comprise an organopolysiloxane compound or another compound. In embodiments where component (B) comprises a silicon-free organic compound, such a compound may comprise at least two aliphatically unsaturated groups. In some embodiments, the second organopolysiloxane compound has at least two aliphatically unsaturated groups. In certain embodiments, component (B) may comprise a mixture of compounds. In one such embodiment, component (B) may comprise the second organopolysiloxane compound, wherein the second organopolysiloxane compound has at least two aliphatically unsaturated groups, and a silicon-free organic compound that has at least two aliphatically unsaturated groups. In still other embodiments, component (B) may comprise a mixture of discrete organopolysiloxane compounds, including the second organopolysiloxane compound, and these compounds may each comprise aliphatic carbon-carbon multiple bonds. In these embodiments, the aliphatic carbon-carbon multiple bond may be included in a terminal group or be located in another group of the organopolysiloxane compound.

Examples of silicon-free organic compounds suitable for use in component (B) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methylhepta-1,5-diene, 3-phenylhexa-1,5-diene, 3-vinylhexa-1,5-diene, and 4,5-dimethyl-4,5-diethylocta-1,7-diene, N,N′-methylenebisacrylamide, 1,1,1-tris(hydroxymethyl) propane triacrylate, 1,1,1-tris(hydroxymethyl) propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6 (1H,3H,5H)trione, diallyl malonate, polyethylene glycol diacrylate, polyethylene glycol dimethacrylate, poly(propylene glycol) methacrylate.

Organopolysiloxane compounds known in the art are suitable for use in component (B) and as the second organopolysiloxane compound. Examples of such organopolysiloxanes include, for example, silicone block copolymers having urea segments, silicone block copolymers having amide segments and/or imide segments and/or ester-amide segments and/or polystyrene segments and/or silarylene segments and/or carborane segments, and silicone graft copolymers having ether groups.

Organopolysiloxane compounds suitable for use as the second organopolysiloxane compound are preferably linear or branched organopolysiloxanes comprising units of the general formula (II)

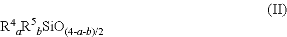

where
R⁴ independently at each occurrence, is a radical free from aliphatic carbon-carbon multiple bonds,
R⁵ independently at each occurrence, identically or differently, is a monovalent, substituted or unsubstituted, SiC-bonded hydrocarbon radical having at least one aliphatic carbon-carbon multiple bond,
a is 0, 1, 2, or 3, and
b is 0, 1, or 2, with the proviso that the sum a+b is less than or equal to 3 and there are at least 2 radicals R⁵ per molecule.
R⁴ has the definition indicated above. In some embodiments, R⁵ comprises any desired groups amenable to an addition reaction (hydrosilylation) with an SiH-functional compound.

If R⁵ comprises SiC-bonded, substituted hydrocarbon radicals, preferred substituents are halogen atoms, cyano radicals, and —OR₆, where R⁶ has the above stated definition.

Preferably, R⁵ comprises alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl, and styryl radicals, with vinyl, allyl, and hexenyl radicals being particularly preferred for use.

The molecular weight of the second organopolysiloxane compound and any organopolysiloxane compound(s) utilized as a portion of component (B) may vary within wide limits, as for instance between 102 and 106 g/mol. Hence, for example, the second organopolysiloxane compound may be a relatively low molecular mass, alkenyl functional oligosiloxane such as, for example, 1,2-divinyltetramethyldisiloxane, or is a polydimethylsiloxane with a molecular weight of 105 g/mol (number average determined by means of NMR) that possesses in-chain or terminal Si-bonded vinyl groups. The structure of the second organopolysiloxane compound may vary between embodiments depending on the desired properties of the composition. Thus, in certain embodiments, in which the second organopolysiloxane compound has a relatively high molecular mass, in other words an oligomeric or polymeric siloxane, the structure may be linear, cyclic, branched, resinous, network-like or another type polymer matrix. Linear and cyclic polysiloxanes are preferably composed of units of the formula R⁴³SiO_{1/2}, R⁵R⁴₂SiO_{1/2}, R⁵R⁴SiO_{1/2}, and R⁴₂SiO_{2/2}, where R⁴ and R⁵ have the definition indicated above. Branched and network-like polysiloxanes additionally include trifunctional and/or tetrafunctional units, with preference being given to those of the formula R⁴SiO_{3/2}, R⁵SiO_{3/2}, and SiO_{4/2}. Also, as noted above, mixtures of these different organopolysiloxanes may be utilized in component (B).

Preferably, the second organopolysiloxane compound is a vinyl-functional, substantially linear polydiorganosiloxane having a viscosity of 0.01 to 500 000 Pa·s, more preferably of 0.1 to 100 000 Pa·s, in each case the viscosity being measured at 25° C.

In some embodiments, the curable composition may contain 30-95 wt %, preferably 30-80 wt %, and more preferably 40-70 wt % of the organopolysiloxane compound(s) of component (B). In other embodiments, the curable composition may contain 0.1-60 wt %, preferably 0.5-50 wt %, and more preferably 1-30 wt % of the organopolysiloxane compound(s) of component (A). If the curable composition comprises an alternative to the organopolysiloxanes described above for use in components (A) and (B), then such an alternative molecule may be present at 30-95 wt %, preferably 30-80 wt %, more preferably 40-70 wt % in the curable composition.

Preferably, the curable composition is an emulsion. In such embodiments, the curable composition has a continuous phase and a discontinuous phase. In one such embodiment, the continuous phase comprises a polysiloxane network and the discontinuous phase is dispersed in the continuous phase. The polysiloxane network may be formed by the product of combining the first organopolysiloxane compound and the second organopolysiloxane compound. In certain embodiments, the continuous phase may also be formed by utilizing one or more additional organopolysiloxane compounds and/or a component (C).

Component (C) may comprise an organopolysiloxane compound. In some embodiments, the organopolysiloxane compound may have one or more terminal groups comprising a silicon atom bonded to a hydrogen atom. In other embodiments, the organopolysiloxane compound may have one or more terminal groups comprising a carbon-carbon multiple bond. In still other embodiments, component (C) may comprise a mixture of organopolysiloxanes. For example, in an embodiment, component (C) may comprise organopolysiloxane compounds having one or more terminal groups comprising a silicon atom bonded to a hydrogen atom, organopolysiloxane compounds having one or more terminal groups comprising a carbon-carbon multiple bond, and/or organopolysiloxane compounds that do not include any reactive groups. Component (C) may also comprise a reinforcing filler. In other embodiments, component (C) may comprise a nonsilicone oligomeric compound such as, for example, a polyether or a polymeric compounds such as, for example, acrylates, urethanes, polyesters, and copolymers of the same with siloxanes.

Alternatively, and instead of utilizing different organopolysiloxane compounds, the polysiloxane network may be formed by providing a single organopolysiloxane compound that simultaneously has aliphatic carbon-carbon multiple bonds and Si bonded hydrogen atoms. In this embodiment, the first organopolysiloxane compound and the second organopolysiloxane compound are chemically the same. However, in this embodiment, first organopolysiloxane compound and the second organopolysiloxane compound may still be provided as portions of separate components.

If an organopolysiloxane compound has aliphatic carbon-carbon multiple bonds and Si-bonded hydrogen atoms is provided, suitable examples are preferably composed of units of the general formula (III), (IV), and (V)

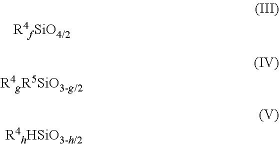

where
R⁴ and R⁵ have the definitions indicated for them above,
f is 0, 1, 2, or 3,
g is 0, 1, or 2, and
h is 0, 1, or 2,
   with the proviso that per molecule there are at least 2 radicals R⁵ and at least 2 Si bonded hydrogen atoms.

Organopolysiloxane compounds that have aliphatic carbon-carbon multiple bonds and Si-bonded hydrogen atoms preferably possess an average viscosity of 0.01 to 500 000 Pa·s, more preferably 0.1 to 100 000 Pa·s, in each case at 25° C. Such organopolysiloxanes are preparable by techniques that are known in the art.

Preferably, the curable composition is cured through crosslinking of the first and second organopolysiloxane compounds. In certain embodiments, the curable composition is formed by addition-crosslinking.

In some embodiments, the curable composition may comprise a crosslinker. Preferably, the crosslinker may be an organopolysiloxane compound. Thus, in these embodiments, the curable composition may comprise a third organopolysiloxane compound. Preferred organopolysiloxane compounds suitable for use as crosslinkers have one or more groups comprising a silicon atom bonded to a hydrogen atom. Preferably, the crosslinker includes an SiH-functional organopolysiloxane compound having an average of at least two SiH groups. In certain embodiments, the crosslinker may be a mixture of various SiH-functional organosilicon compounds. Preferably, the crosslinker includes a linear, cyclic, branched or resinous organopolysiloxane having Si bonded hydrogen atoms, composed of units of the formula

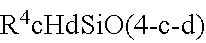

where
R⁴ has the definition given above,
c is 0, 1, 2 or 3 and
d is 0, 1 or 2,
with the proviso that the sum total of (c+d) is not more than 3 and there is an average of at least two Si-bonded hydrogen atoms per molecule.

Preferably, the crosslinker contains SiH groups in the range from 0.04 to 1.7 percent by weight (% by weight) based on the total weight of the organopolysiloxanes utilized as crosslinkers. In these embodiments, the molecular weight of the crosslinker may vary within wide limits, for instance between 102 and 106 g/mol. For example, in some embodiments, the crosslinker may be an SiH-functional organopolysiloxane compound of relatively low molecular weight, such as tetramethyldisiloxane, a high polymeric polydimethylsiloxane having SiH groups in chain or terminal positions, or a silicone resin having SiH groups. Preference is given to the use of organopolysiloxane crosslinkers of low molecular weight, such as tetrakis(dimethyl-siloxy) silane and tetramethylcyclotetrasiloxane and SiH-containing organopolysiloxanes, such as, for example, poly(hydrogenmethyl) siloxane and poly(dimethylhydrogenmethyl) siloxane having a viscosities in the range of 10 to 1000 mPas (at 25° C. and 0.8 sec⁻¹). Preferably, the crosslinker is compatible with RTV-2 siloxane systems (homogeneously miscible or at least emulsifiable).

In order to crosslink the organopolysiloxanes provided in the composition, a hydrosilylation catalyst is provided. The hydrosilyation catalyst may be provided as a portion of one of the components mentioned above.

When the composition is formed by mixing a component (A) and a component (B), the two components may comprise all constituents referred to above in any desired combinations, generally with the proviso that one component does not simultaneously comprise organopolysiloxane compounds with aliphatic multiple bonds, organopolysiloxane compounds with Si-bonded hydrogen atoms, and the hydrosilylation catalyst. Thus, in the case of a two-component composition, the hydrosilyation catalyst may be provided as a portion of component (A) or component (B).

Hydrosilylation catalysts known in the art are suitable for use in the curable composition. The hydrosilylation catalyst may include a platinum-group metal such as, for example, platinum, rhodium, ruthenium, palladium, osmium, or iridium, or may be an organometallic compound, or a combination thereof. Suitable examples of hydrosilylation catalysts are compounds such as hexachloroplatinic (IV) acid, platinum dichloride, platinum acetylacetonate, and complexes of said compounds encapsulated in a matrix or in a core/shell-like structure. Other suitable platinum complexes with a low molecular weight of organopolysiloxanes include 1,3-diethenyl-1,1,3,3-tetramethyldisiloxane complexes with platinum. Other examples of suitable hydrosilylation catalysts are platinum-phosphite complexes, platinum-phosphine complexes, or alkylplatinum complexes such as derivatives of cyclopentadienyltrimethylplatinum (IV), cyclooctadienyldimethylplatinum (II), or diketonato complexes, such as bisacetylacetonatoplatinum (II), for example. In certain embodiments, the platinum-containing compound may be encapsulated within a resin matrix.

The concentration of catalyst for catalyzing the hydrosilylation crosslinking reaction may be in an amount between 0.1 and 1000 parts per million (ppm), 0.5 and 100 ppm, or 1 and 25 ppm of the platinum group metal, depending on the total weight of the curable composition.

In the embodiments described above, after curing, the composition may be a gel. In these embodiments, the gel has a crosslinked structure. A crosslinked structure can form when the total number of reacting groups is greater than 4. Thus, for a gel formed by a platinum catalyzed hydrosilylation reaction, crosslinking can happen, for example, between a first organopolysiloxane compound, which contains more than two Si-bonded hydrogen atoms, and a second organopolysiloxane compound, which includes at least two reactive aliphatically unsaturated groups, or alternatively between a first organopolysiloxane compound containing two Si-bonded hydrogen atoms and a second organopolysiloxane compound with more than two aliphatically unsaturated radicals. Preferably, in these embodiments, the first organopolysiloxane compound and the second organopolysiloxane compound are crosslinked to the gel point of the mixture. In such embodiments and before curing, the curable composition may exhibit a viscosity of 50-100,000 centipoise.

The curable composition comprises an organopolysiloxane resin. The curable composition may comprise 0.5 wt % or more organopolysiloxane resin, based on the total weight of the composition. In some embodiments, the curable composition comprises 0.5 to 5 wt % organopolysiloxane resin, which is based on the total weight of the composition. Preferably, the curable composition comprises 1 to 3 wt % organopolysiloxane resin, which is based on the total weight of the composition.

In an embodiment, the organopolysiloxane resin is a vinyl functional MQ resin or similar, highly crosslinked resin containing M, Q, and/or T moieties, and optionally a minor amount of D moieties. As used herein, the term “resin” is used in its customary meaning, i.e. a highly three dimensionally crosslinked polymer containing a majority of M units, and T and/or Q units. In certain embodiments, an MT, MQ, and MQT resin is preferred. An organopolysiloxane resin that comprises M and Q units is particularly preferred.

The term “M” refers to monofunctional units while the term “Q” refers to tetrafunctional units. In other words, an MQ resin comprises predominantly M units, wherein silicon is attached to only one oxygen in the cross-linked molecules, and SiO_{4,2} “Q” units, wherein each silicon atom is attached to four other oxygen atoms, resulting in a high level of crosslinking. In some embodiments, the MQ resin may comprise small amounts of difunctional R²SiO_{2/2} units and trifunctional RSiO3/2 units (“D” and “T” units, respectfully). MQ resins suitable for use in the curable composition may be produced by the hydrolysis of silanes such as tetraethoxysilane, vinyldimethylethoxysilane and trimethylethoxysilane. In some embodiments, the MQ resin may retain some residual alkoxy functionality as a result of the method of its preparation and will occasionally include other functionalities such as silanol or halo functionality as well. Preferably, the MQ resin contains approximately 1.2 to 1.8 weight percent vinyl functionality. MQ resins having unsaturated groups other than vinyl, including vinyloxy, allyl, allyloxy, propenyl, etc., may also be utilized.

In certain embodiments, MQ resins formed as a co-hydrolysis product of tetraalkoxy silane and trimethylalkoxy silane may be suitable. Such MQ resins may comprise a three-dimensional network of polysilicic acid units that has trimethylsilyl end groups. The average molecular weight of such MQ resins can be controlled by the ratio of M to Q units in the resin. Preferably, the ratio of M to Q units is from 0.5 to 1, with a ratio of approximately 0.67 being preferred.

The embodiments of the MQ resins mentioned above may be used alone, in combination with each other, or with other unsaturated resins. Preferred commercially available MQ resins include MQ resin 804 and MQ resin 803, both are available from Wacker Chemical Corporation.

The organopolysiloxane resin, as indicated, may contain a variety of unsaturated groups for the above-mentionedhydrosilylation reactions, including both ethylenic and unsaturation. It is preferable, although not mandatory, that the unsaturation be at a terminal location. For example, when hexenyl unsaturated groups are present, terminal (co-) hexenyl groups are preferred. The unsaturated groups may also, as indicated, be unsaturated ether groups such as vinyl ether groups, and may be other heteroatom containing groups as well, i.e. (meth)acryloxy groups. Vinyl and allyl groups are most preferred.

Before curing, the curable composition is an emulsion that comprises a continuous phase and a discontinuous phase. The presence of the organopolysiloxane resin reduces the interfacial tension between the continuous phase and the discontinuous phase of the curable composition. As used herein, the term interfacial tension refers to a measure of work per unit area or force per wetted length that can be determined according to the Wilhelmy plate method. The interfacial tension values referred to herein are measured at a liquid/liquid interface between the continuous phase and the discontinuous phase of the curable composition.

While not wishing to be bound by a particular theory, it is believed that the interaction between the hydrophilic compound and the organopolysiloxane compounds in the curable composition result in the separation of the continuous phase and the discontinuous phase into at least two visibly distinct layers. However, the reduction in interfacial tension between the continuous phase and the discontinuous phase related to the use of the organopolysiloxane resin in the curable composition increases the compatibility of these phases. This increase in compatibility eliminates observable phase separation in the curable composition when all of the components thereof are mixed together such that the composition appears to be a homogenous mixture prior to curing.

Thus, the inclusion of the organopolysiloxane resin provides a composition that exhibits a interfacial tension that is lower than those exhibited by the known compositions. In fact, in some embodiments of the curable composition, the interfacial tension between the continuous phase and the discontinuous phase is 28 mN/m or less. In other embodiments, the interfacial tension between the continuous phase and the discontinuous phase of the curable composition is 22 to 28 mN/m. More preferably, the interfacial tension between the continuous phase and the discontinuous phase of the curable composition is 24 to 28 mN/m. The interfacial tension can be measured using a commercially available interfacial tension measuring instrument. An example of a suitable commercially available instrument is a K100 force tensiometer available from KRÜSS Scientific Instruments, Inc.

Furthermore, in the curable composition the compatibility of the phases can be established quickly by mixing with commercially available mixing equipment and standard mixing processes. The compatibility of the continuous phase and the discontinuous phase can also be maintained for a commercially significant time, which allows for the curable composition to be transported and applied to a substrate prior to curing. For example, in certain embodiments, the curable composition does not exhibit an observable phase separation for at least 24 hours at 23° C. and a relative humidity of 55% or after being centrifuged at 23° C. and 5000 rpm for 5 minutes. Preferably, the curable composition does not exhibit an observable phase separation after 90 days at 23° C. and a relative humidity of 55% or after being centrifuged at 23° C. and 5000 rpm for 5 minutes. In certain embodiments, the curable composition may not exhibit an observable phase separation after 9 months at 23° C. and a relative humidity of 55% after being centrifuged for 5 minutes. It should be noted that the curable composition can be formed by mixing for less than or in excess of 5 minutes, e.g. for 3 minutes or 40 minutes or more, and that extended mixing, e.g. centrifugation, does not materially effect the stability of the curable composition or make it more likely that a phase separation will be observed. The elimination of an observable phase separation for a commercially significant time enables the curable composition to be utilized in traditional wound care dressings and form a homogenous gel adhesive layer after being applied to a desired substrate and cured.

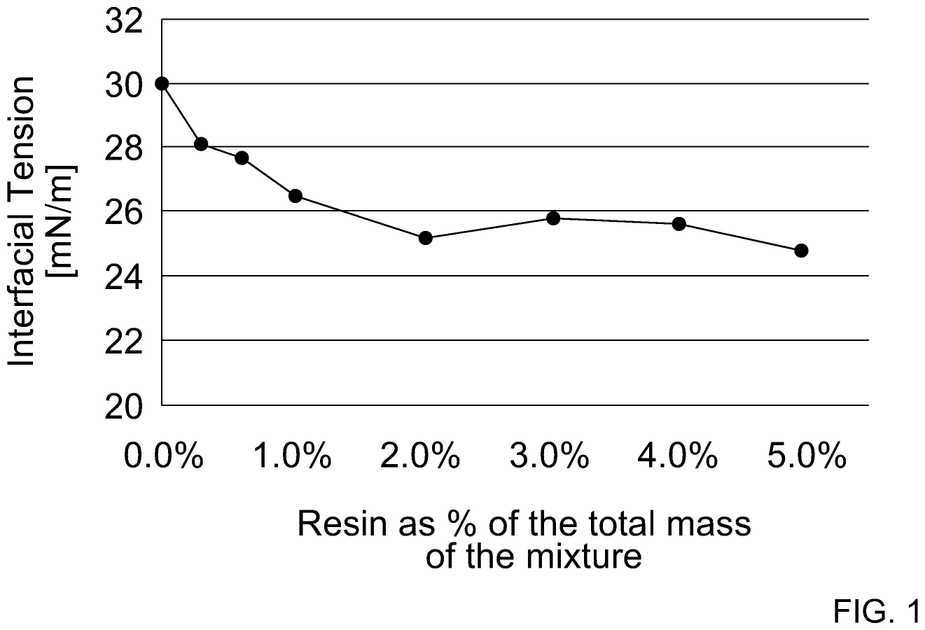

The impact on providing the organopolysiloxane resin with the organopolsiloxane compounds, hydrophilic compound, and other components of the curable composition and improvement in interfacial tension can be seen in the examples illustrated in FIG. 1. In the examples illustrated in FIG. 1, the continuous phase comprises an organopolysiloxane compound and the discontinuous phase comprises a hydrophilic compound. More particularly, in the examples illustrated in FIG. 1, the organopolysiloxane compound comprised a organopolysiloxane having one or more groups comprising a carbon-carbon multiple bond, in particular, WACKER VIPO 1000 polymer, and the hydrophilic compound was glycerol. As illustrated in FIG. 1, in the absence of the organopolysiloxane resin, the interfacial tension between the continuous phase and the discontinuous phase is greater than 28 mN/m. Also, as illustrated in FIG. 1, the addition of the organopolysiloxane resin reduces the interfacial tension between the continuous phase and the discontinuous phase to 28 mN/m or less over the entire range shown.

The curable composition comprises a silver-containing antimicrobial agent. In certain embodiments, the silver-containing antimicrobial agent is a silver salt with antimicrobial properties. The silver-containing antimicrobial agent can be selected from the group comprising Ag₂SO₄, Ag₂SO₃, AgNO₃, Ag₂CO₃, Ag₃PO₄, silver zirconium, and/or organic silver salts, such as silver citrate, silver acetate, silver lactate and/or combinations or mixtures thereof. Other compounds suitable for providing silver ions when desired are also suitable as the silver-containing antimicrobial agent. The silver containing antimicrobial agent may be provided in the curable composition at about 1 weight percent (wt %) to about 30 wt %, preferably, about 2 to 20 wt %, in all cases based on the total weight of the composition. The silver-containing antimicrobial agent may be provided as a portion of a component (A), component (B), component (C), in two or more of these components, or as a separate addition to the composition.

The curable composition may comprise an excipient. When provided, the excipient inhibits the silver-containing antimicrobial agent from forming elemental silver or silver oxide to the extent that the curable composition may not exhibit an observable change in color after exposure to air having a relative humidity of 50% at 25° C. for 24 hours.

The curable composition may comprise 0.5 wt % or more of the excipient, based on the total weight of the composition. Preferably, when provided, the curable composition comprises 0.5 to 15 wt % of the excipient, based on the total weight of the composition. More preferably, the curable composition comprises 0.5 to 10 wt % of the excipient, based on the total weight of the composition. The excipient may be provided as a portion of component (A), component (B), component (C), or in two or more of these components.

Preferably, when provided, the weight percent of the excipient in the curable composition is greater than the weight percent of the silver-containing antimicrobial agent in the curable composition, based on the total weight of the composition. For example, the weight percent of the excipient present in the curable composition may be 2 or more times greater than the weight percent of the silver-containing antimicrobial agent. In an embodiment, the weight percent of the excipient present in the curable composition is 2 to 10 times greater than the weight percent of the silver-containing antimicrobial agent.

In some embodiments, the excipient is an alcohol and comprises one or more hydroxyl groups. In other embodiments, the excipient may be a glycol. In these embodiments, the excipient has two or more hydroxyl groups and two hydroxyl groups of the two or more hydroxyl groups may be connected to different carbon atoms. In one such embodiment, the two hydroxyl groups of the two or more hydroxyl groups are end groups. In some embodiments, the excipient is a polyether.

In an embodiment, the excipient has a number average molecular weight of 100 g/mol or more. In other embodiments, the excipient may have a number average molecular weight of 300 g/mol or more. Preferably, the excipient has a relatively low number average molecular weight. In one such embodiment, the excipient has a number average molecular weight of 300-2,000 g/mol. In another embodiment, the number average molecular weight of the excipient is 300-1000 g/mol. Preferably, in these embodiments, the number average molecular weight of the excipient is 300-600 g/mol.

In some embodiments, the excipient may be selected from the group consisting of poly(propylene glycol) having a number average molecular weight of 400-2000 g/mol, 1,2-propanediol, di(propylene glycol), di(propylene glycol) monomethyl ether, di(propylene glycol)dimethyl ether, organopolysiloxane polyoxyalkylenes, copolymers, and mixtures thereof. In certain embodiments, it may be preferred that the excipient is poly(propylene glycol) having a number average molecular weight of 400-2000 g/mol. Preferably, in these embodiments, the excipient is poly(propylene glycol) having a number average molecular weight of 400 g/mol. In other embodiments, it may be preferred that the excipient is an organopolysiloxane polyoxyalkylene. Preferably, in these embodiments, the excipient is an organopolysiloxane polyoxyalkylene of the general formula:

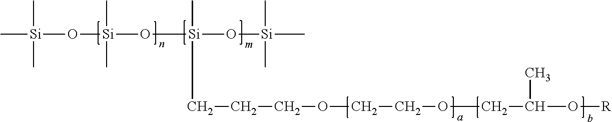

In certain embodiments, the organopolysiloxane polyoxyalkylene may be covelantly bonded. An example of a commercially available organopolysiloxane polyoxyalkylene suitable as the excipient is sold under the name Belsil® OW 1500 and by Wacker Chemie AG. As noted above, the curable composition has a discontinuous phase. When provided, the excipient is present in the discontinuous phase.

The curable composition may comprise one or more additives, which may be provided as a portion of component (A), component (B), or component (C). For example, as mentioned above, the anti-microbial composition may comprise a reinforcing filler. Suitable reinforcing fillers include fumed or precipitated silicas having BET surface areas of at least 50 m²/g, carbon blacks, activated carbons such as furnace black and acetylene black, or mixtures thereof. The stated silica fillers may have a hydrophilic character or may have been made hydrophobic by known methods. The amount of reinforcing filler in the curable composition may be within the range from 0 to 70 wt %, preferably 0 to 50 wt %, based on the total weight of the curable composition.

In certain embodiments, it is preferred that the filler utilized is surface-treated. The surface treatment is obtained by the methods known in the art for hydrophobizing finely divided fillers. As a result of a surface treatment, the filler utilized may have a carbon content of at least 0.01 up to a maximum of 20 wt %, preferably between 0.1 and 10 wt %, more preferably between 0.5 to 5 wt %. Preferably, in these embodiments, the filler is a surface-treated silica having 0.01 to 2 wt % of Si-bonded, aliphatically unsaturated groups. These groups are, for example, Si-bonded vinyl groups. In the curable composition, the filler is provided as a single species or as a mixture of two or more finely divided filler(s).

Further additives may be provided in the curable composition in a fraction of up to 70 wt %, preferably 0.0001 to 40 wt %, based on the total weight of the composition. These additives may be, for example, inert fillers, resinous polyorganosiloxanes, different from the siloxanes described above, reinforcing and nonreinforcing fillers, fungicides, fragrances, rheological additives, corrosion inhibitors, oxidation inhibitors, light stabilizers, flame retardants, and agents for influencing the electrical properties, dispersing assistants, solvents, adhesion promoters, pigments, dyes, plasticizers, organic polymers, heat stabilizers, etc. These include additives, such as finely ground quartz, diatomaceous earth, clays, chalk, lithopone, carbon blacks, graphite, metal oxides, metal carbonates, metal sulfates, metal salts of carboxylic acids, metal dusts, fibers, such as glass fibers, polymeric fibers, polymeric powders, metal dusts, dyes, pigments, etc. Additional fillers may be heat-conducting or electrically conducting. A combination of fillers with different particle sizes and different particle size distributions may also be utilized.

Further, the curable composition may comprise additional additives such as one or more solvents and/or one or more inhibitors. For example, in some embodiments, the curable composition may comprise a hydrosilyation inhibitor. Such inhibitors enable the curable composition to exhibit a predetermined processing life, curing onset temperature, and curing rate. Examples of suitable inhibitors are acetylenic alcohols, such as 1-ethynyl-1-cyclohexanol, 2-methyl-3-butyn-2-ol, and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular mass silicone oils with methylvinyl-SiO_{1/2} groups and/or RavinylSiO1/2 end groups, such as divinyltetramethyldisiloxane, tetravinyldimethyldisiloxane, trialkyl cyanurates, alkyl maleates, such as diallyl maleates, dimethyl maleate, and diethyl maleate, alkyl fumarates, such as diallyl fumarate and diethyl fumarate, organic hydroperoxides such as cumene hydroperoxide, tert-butyl hydroperoxide, and pinane hydroperoxide, organic peroxides, organic sulfoxides, organic amines, diamines and amides, phosphanes and phosphites, nitriles, triazoles, diaziridines, and oximes. In certain embodiments, the hydrosilylation inhibitor is provided in the curable composition in a quantitative fraction of 0.00001 to 5 wt %, based on the total weight of the curable composition. Preferably, the hydrosilylation inhibitor is provided in the curable composition in an amount of 0.00005 to 2 wt %, and more preferably at 0.0001 to 1 wt %, which in each case is based on the total weight of the composition.

The curable composition comprises a hydrophilic compound. The hydrophillic compound is provided to enhance silver release from the composition. In these embodiments, the silver-containing antimicrobial agent and the hydrophillic compound are present in the discontinuous phase. Preferably, the hydrophillic compound is a polyol. Preferred polyols include those that are polyhydric alcohols or polyethers. Examples of suitable polyhydric alcohols for use in the curable composition may be selected from the group consisting of sorbitol and mannitol. Examples of suitable polyethers for use in the curable composition may be selected from the group consisting of polyethylene gylcol and polypropylene gylcol. A preferred polyol is glycerol. In certain embodiments, the hydrophilic compound is present in the composition at 3 to 40 wt %, preferably, about 3 to 30 wt %, in all cases based on the total weight of the composition. The hydrophillic compounds mentioned above may make the curable composition, when cured and as a gel, swell by at least 5% after 24 hours in a water solution containing 8.298 g/L of sodium chloride and 0.368 g/L of calcium chloride dihydrate, as measured by the free swell absoption method. An advantage of such swelling performance is the antimocrobial efficacy exhibited when a silver-containing antimicrobial agent is utilized, which can achieved without using a high concentration of silver-containing antimicrobial agent in the gel.

As noted above, after being cured and as a gel, the curable composition may also function as an adhesive. In these embodiments, the adhesive may be utilized as the adhesive portion of a wound care dressing. Advantageously, when gelled, the composition can function as an adhesive because the tack exhibited is sufficiently high despite the presence of a hydrophilic component, which typically leads to phase separation due to density differences between the hydrophilic component and the organopolysiloxane compounds. For example, in certain embodiments, the tack exhibited by the gel may be greater than 50 grams of force (gf). Preferably, the tack exhibited by the gel is greater than 100 gf. However, the tack must not be so strong that the skin of the user is damaged when the dressing is removed. Thus, in some embodiments, the tack exhibited by the gel is less than 800 gf. In these embodiments, the tack exhibited by the gel may be 50-800 gf. The tack exhibited by the gel can be measured by known methods. For example, the tack of the gel can be measured with a TA.XT Plus Texture Analyzer using a TA-57R probe and a TA-303 apparatus.

In addition to a suitable tack, it is preferred that the gel is cohesive. A cohesive gel does not break apart or leave a significant visible residue when removed from a surface it has been adhered to. In some embodiments, the gel may exhibit a post-cure penetration hardness of 25-500 1/10 mm measured according to DIN ISO 2137 using a hollow cone of 62.5 grams for 60 seconds after curing for 60 minutes at 120° C.

As noted above, the curable composition may form a gel after being applied to a substrate. In some embodiments, the curable composition may coat a substrate such as, for example, a dressing. In these embodiments, the curable composition may be cast and cured on the substrate to form the gel. The curable composition can be applied to the substrate to provide any desired thickness, pattern, or morphology. Suitable substrates are known in the art.

In advance of forming the gel, the curable composition may be made by preparing component (A). Preferably, component (A) comprises the organopolysiloxane(s) described above for component (A). Additionally, component (A) may comprise a silver containing antimicrobial agent, an excipient, a hydrosilyation catalyst, the organopolysiloxane resin, the hydrophilic compound and/or one or more additional additives. When included in component (A), the silver-containing antimicrobial agent, excipient, hydrosilyation catalyst, organopolysiloxane resin, hydrophilic compound and the one or more additinal additives may be mixed with the organopolysiloxane(s) to form a mixture. Mixing can be done at a predetermined rate, for a predetemined period of time, and utilizing commercially available mixing devices such as, for example, a Speedmixer® or a Dispermat® fitted with a dissolver blade. The silver-containing antimicrobial agent, excipient, hydrosilyation catalyst, hydrophilic compound and the one or more additonal additives may be as described above.

In certain embodiments, the curable composition may be made by preparing component (B). Preferably, component (B) comprises the organopolysiloxane described above for component (B). Additionally, component (B) may comprise the silver containing antimicrobial agent, excipient, hydrosilyation catalyst, organopolysiloxane resin, hydrophilic compound, and/or one or more additonal additives. When included in component (B), the silver-containing antimicrobial agent, excipient, hydrosilyation catalyst, organopolysiloxane resin, hydrophilic compound, and the one or more additional additives may be mixed with the organopolysiloxane to form a mixture. Mixing can be done at a predetermined rate, for a predetemined period of time, and utilizing commercially available mixing devices such as, for example, a the mixing devices mentioned above. The silver-containing antimicrobial agent, excipient, hydrosilyation catalyst, organopolysiloxane resin, hydrophilic compound and one or more additional additives may be as described above.

In embodiments where the curable composition comprises component (C), the curable composition is made by preparing component (C). In these embodiments, the curable composition may be made by preparing three mixtures and combining those mixtures. Preferably, component (C) comprises an organopolysiloxane like those described above for component (C). Additionally, component (C) may comprise the silver-containing antimicrobial agent, excipient, hydrosilyation catalyst, hydrophilic compound and/or one or more additional additives. When included in component (C), the silver-containing antimicrobial agent, excipient, hydrosilyation catalyst, hydrophilic compound and/or one or more additional additives may be mixed with the organopolysiloxane to form a mixture. Thus, in these embodiments, the curable composition may be made by initially preparing three mixtures. Mixing can be done at a predetermined rate, for a predetemined period of time, and utilizing commercially available mixing devices as described above. The silver-containing antimicrobial agent, excipient, hydrosilylation catalyst, hydrophilic compound and the one or more additional additives may be as described above.

In certain embodiments, and prior to coating the substrate, component (A) and component (B) may be mixed to form a mixture. Mixing can be done at a predetermined rate, for a predetemined period of time, and utilizing commercially available mixing devices such as, for example, the mixing devices mentioned above. In some embodiments, the mixture may also include component (C). If not included in components (A), (B) or (C) or if additional amounts are desired to be included in the curable composition, the silver-containing antimicrobial agent, excipient, hydrosilyation catalyst, organopolysiloxane resin, hydrophilic compound and/or one or more additional additives can be added to the mixture. The addition of one or more of these components can be achieved at the time of mixing component (A), component (B), component (C) or can occur simultaneously or sequentialy by way of further mixing. After mixing, one or more portions of the substrate can be coated with the curable composition and the composition can be cured at a predetermined temperature and for a predetermined period of time. For example, the mixture can be cured at a temperture of 40-140° C., preferably 60-130° C., for 5 seconds to 2 hours, preferably 10 seconds to 30 minutes.

In certain embodiments, component (A) is prepared such that it comprises an organopolysiloxane having one or more groups comprising a silicon atom bonded to a hydrogen atom. In this embodiment, the curable composition is made by mixing a silver containing antimicrobial agent, a hydrophillic component, and an organopolysiloxane resin with the organopolysiloxane having one or more groups comprising a silicon atom bonded to a hydrogen atom. Preferably, the hydrophillic compound is a polyol like those described above. In an embodiment, component (B) is prepared such that it comprises an organopolysiloxane having one or more terminal groups comprising a carbon-carbon multiple bond. Preferably, component (B) also comprises one or more additives such as, for example, a reinforcing filler. However, in certain embodiments, it may be preferred that component (B) is formed by mixing the silver-containing antimicrobial agent with the organopolysiloxane having one or more terminal groups comprising a carbon-carbon multiple bond. In these embodiments, component (A) may not comprise the silver containing antimicrobial agent. The curable composition is preferrable formed by forming a mixture. In certain embodiments, the mixture comprises component (A), component (B), a hydrosilylation catalyst, and, optionally, a hydrosilylation inhibitor. An antimicrobial gel is formed by curing the mixture.

### Examples

The following examples are presented solely for the purpose of further illustrating and disclosing the embodiments of the curable composition. Examples of the curable composition include Examples 1-7, which are described below. Comparative Examples, which are not part of the invention, are also described below.

### Comparative Example 1

composition was formed by mixing 5 grams of a WACKER VIPO 1000 polymer, which includes an organopolysiloxane having two terminal groups, each terminal group comprising a carbon-carbon multiple bond. The organopolysiloxane has a molecular weight of about ~16000 g/mol (viscosity of ~1000 cSt.). The composition also included 1.15 grams of WACKER H polymer 1000, which includes an organopolysiloxane having a molecular weight of about ~16000 g/mol (~1000 cSt.) and one or more groups comprising a silicon atom bonded to a hydrogen atom, and 0.05 grams of WACKER H018 crosslinker, which is an hydrogenorgonosiloxane crosslinker having at least 3 groups that comprise a silicon atom bonded to a hydrogen atom, and 0.5 grams of glycerol. Mixing the components was conducted for 5 minutes at 23° C. and a relative humidity of 55% using a SpeedMixer® at 2350 rpm. The resulting composition was a fluid that exhibited an observable phase separation immediately after mixing. An interfacial tension (IFT) measurement was taken at the glycerol and siloxane interface prior to mixing all components together. The measurement was taken utilizing a K100 force tensiometer. The IFT measurement was ~30 mN/m.

### Comparative Example 2

A composition was formed by mixing 5 grams of WACKER H polymer 1000 and 0.5 grams of glycerol additive for 5 minutes at 23° C. and a relative humidity of 55% using a SpeedMixer® at 2350 rpm. The composition exhibited an observable phase separation immediately after mixing at 23° C. and a relative humidity of 55% or after being centrifuged at 23° C. and 5000 rpm for 3 minutes. An IFT measurement was taken at the glycerol and siloxane interface prior to mixing all components utilizing a K100 force tensiometer. The IFT measurement was ~30 mN/m.

### Comparative Example 3

A composition was formed by mixing 5 grams of a WACKER VIPO 1000 polymer and 0.5 grams of glycerol for 5 minutes at 23° C. and a relative humidity of 55% using a SpeedMixer® at 2350 rpm. The composition exhibited an observable phase separation immediately after mixing. An IFT measurement was taken at the glycerol and siloxane interface prior to mixing all components utilizing a K100 force tensiometer. The IFT measurement was ~30 mN/m.

### Example 1

A composition was formed by mixing a component (A) and a component (B). Component (A) comprised 1.15 grams of WACKER H polymer 1000 and 5 grams of WACKER VIPO 1000 polymer was added after mixing the components mentioned below in order to form the composition. Component (B) comprised 5 grams of a WACKER VIPO 1000 polymer, 0.1 grams of WACKER MQ804 resin, which is a co-hydrolysis product of tetraalkoxy silane (Q unit) and trimethylalkoxy silane (M unit) and contains carbon-carbon multiple bonds and some residual ethoxy and hydroxy functions, and 0.1 to 500 ppm by weight of platinum-containing hydrosilylation catalyst, which is based on the content of the platinum of the vinyl platinum-containing hydrosilylation catalyst relative to the overall adhesive formulation. The composition also included 1 wt % of an inhibitor known as PT 730 VS WACKER, which is a divinyldimethylsiloxane, based on the total weight of the composition. The composition also included 0.5 grams of a mixture of silver sulfate and pyrogenic silica. The mixture of silver sulfate and pyrogenic silica was 99% silver sulfate and 1% pyrogenic silica, based on the total weight of the mixture. The composition also included 0.5 grams of glycerol.

To form the composition, all of the components were mixed together for 5 minutes at 23° C. and a relative humidity of 55% using a SpeedMixer® at 2350 rpm. After mixing, an emulsion was formed that had a continuous phase and a discontinuous phase. The composition did not exhibit an observable phase separation at 23° C. and a relative humidity of 55% or after being centrifuged at 23° C. and 5000 rpm for 3 minutes. Further, the composition was stored and monitored for 3 months at 23° C. and a relative humidity of 55% and did not exhibit any observable phase separation during this period.

An IFT measurement was taken for a mixture that included the 5 grams of VIPO 1000, 0.1 grams of WACKER MQ804 resin, and 0.5 grams of glycerol at the glycerol and siloxane interface prior to mixing in all of the other components of the composition together. The IFT measurement was made for a mixture containing only the three components mentioned above because it would be understood by those skilled in the art that the addition of the other components of the composition would not have an appreciable impact on the IFT at the glycerol and siloxane interface composition. The IFT measurement was made utilizing a K100 force tensiometer and was 25.2 mN/m.

### Example 2

A composition was formed by mixing a component (A) and a component (B). Component (A) comprised 1.15 grams of WACKER H polymer 1000, 0.05 grams of WACKER H018 crosslinker, which is an organosiloxane crosslinker where at least 3 groups comprising a silicon atom bonded to a hydrogen atom, and 5 grams of WACKER VIPO 1000 polymer.

Component (B) comprised 5 grams of a WACKER VIPO 1000 polymer, 0.1 grams of WACKER MQ804 resin, and 0.1 to 500 ppm by weight of platinum-containing hydrosilylation catalyst. The formulation also includes 1 wt % of an inhibitor known as PT 730 VS WACKER based on the total weight of the composition.

The composition also included 0.5 grams of a mixture of silver sulfate and pyrogenic silica. The mixture of silver sulfate and pyrogenic silica was 99% silver sulfate and 1% pyrogenic silica, based on the total weight of the mixture. The composition also included 0.5 grams of glycerol.

To form the composition, the components were mixed for 5 minutes at 23° C. and a relative humidity of 55% using a SpeedMixer® at 2350 rpm. After mixing, an emulsion was formed that had a continuous phase and a discontinuous phase. The composition did not exhibit an observable phase separation at 23° C. and a relative humidity of 55% or after being centrifuged at 23° C. and 5000 rpm for 3 minutes. Further, the composition was stored and monitored for 3 months at 23° C. and a relative humidity of 55% and did not exhibit any observable phase separation during this period.

An IFT measurement was taken for component (B) at the glycerol and siloxane interface prior to mixing all of the components included in composition utilizing a K100 force tensiometer. It would be understood by those skilled in the art that IFT at the glycerol and siloxane interface of component (B) would be substantially similar to the IFT for the composition. The IFT measurement was 25.2 mN/m.

### Example 3

Five grams of a WACKER VIPO 1000 polymer, 0.05 grams WACKER MQ804 resin, and 0.5 grams glycerol was mixed for 5 minutes using a SpeedMixer® at 2350 rpm sec. The mixture showed no observable phase separation immediately after mixing at 23° C. and a relative humidity of 55% or after being centrifuged at 23° C. and 5000 rpm for 3 minutes. An IFT measurement was taken at the glycerol and VIPO 1000 interface after mixing in the MQ804 resin utilizing a K100 force tensiometer. The IFT measurement was 25.5 mN/m. This example illustrates that the presence or absence of the silver-containing antimicrobial agent does not meaningfully impact the interfacial tension of the curable composition.

### Example 4

A composition was formed by mixing a component (A) and a component (B) composition. Component (A) comprised a mixture of 1.15 grams of WACKER H polymer 1000, 0.05 grams of WACKER H018 crosslinker. Component (B) comprised a mixture of 5 grams of a WACKER VIPO 1000 polymer and 0.5 grams of glycerol and a WACKER MQ804 organopolysiloxane resin at 2 wt. % loading based on the total mass of the composition. An IFT measurement was taken at the glycerol and VIPO 1000 interface prior to mixing the components together utilizing a K100 force tensiometer. The IFT measurement was 25.5.0 mN/m.

The composition was formed by mixing component (A) composition and component (B) composition for 5 minutes using a SpeedMixer® at 2350 rpm for 30 seconds. The mixture showed no observable phase separation immediately after mixing at 23° C. and a relative humidity of 55% or after being centrifuged at 23° C. and 5000 rpm for 3 minutes.

### Example 5

A composition was formed by mixing a component (A) and a component (B). Component (A) comprised a mixture of 1.15 grams of WACKER H polymer 1000, 0.05 grams of WACKER H018 crosslinker. Component (B) comprised a mixture of 5 grams of a WACKER VIPO 1000 polymer and 0.5 grams of glycerol and a WACKER MQ804 organopolysiloxane resin at 3 wt. % based on the total mass of the composition. An IFT measurement was taken at the glycerol and VIPO 1000 interface prior to mixing the components together utilizing a K100 force tensiometer. The IFT measurement was 25.8 mN/m.

The composition was formed by mixing component (A) and component (B) for 5 minutes using a SpeedMixer® at 2350 rpm for 30 seconds. The mixture showed no observable phase separation immediately after mixing at 23° C. and a relative humidity of 55% or after being centrifuged at 23° C. and 5000 rpm for 3 minutes.

### Example 6

A composition was formed by mixing a component (A) and a component (B). Component (A) comprised a mixture of 1.15 grams of WACKER H polymer 1000, 0.05 grams of WACKER H018 crosslinker. Component (B) comprised a mixture of 5 grams of a WACKER VIPO 1000 polymer and 0.5 grams of glycerol and a WACKER MQ804 organopolysiloxane resin at 4 wt. % concentration against the total mass of the composition. An IFT measurement was taken at the glycerol and VIPO 1000 interface prior to mixing with the components together utilizing a K100 force tensiometer. The IFT measurement was 25.6 mN/m.

The composition was formed by mixing component (A) and component (B) for 5 minutes using a SpeedMixer® at 2350 rpm for 30 seconds. The mixture showed no observable phase separation immediately after mixing at 23° C. and a relative humidity of 55% or after being centrifuged at 23° C. and 5000 rpm for 3 minutes.

### Example 7

A composition was formed by mixing a component (A) and a component (B). Component (A) comprised a mixture of 1.15 grams of WACKER H polymer 1000, 0.05 grams of WACKER H018 crosslinker. Component (B) comprised a mixture of 5 grams of a WACKER VIPO 1000 polymer and 0.5 grams of glycerol and a WACKER MQ804 organopolysiloxane resin at 5 wt. % concentration against the total mass of the composition. An IFT measurement was taken at the glycerol and VIPO 1000 interface prior to mixing the components utilizing a K100 force tensiometer. The IFT measurement was 25.2 mN/m.

The composition was formed by mixing component (A) and the component (B) composition for 5 minutes using a SpeedMixer® at 2350 rpm for 30 seconds. The mixture showed no observable phase separation immediately after mixing at 23° C. and a relative humidity of 55% or after being centrifuged at 23° C. and 5000 rpm for 3 minutes.

From the foregoing detailed description, it will be apparent that various modifications, additions, and other alternative embodiments are possible without departing from the true scope and spirit. The embodiments and examples discussed herein were chosen and described to provide the best illustration of the principles of the invention and its practical application to thereby enable one of ordinary skill in the art to use the invention in various embodiments and with various modifications as are suited to the particular use contemplated. As should be appreciated, all such modifications and variations are within the scope of the invention.

1. A curable composition, comprising:
a first organopolysiloxane compound having one or more groups comprising a silicon atom bonded to a hydrogen atom;
a second organopolysiloxane compound having one or more groups comprising a carbon-carbon multiple bond;
a hydrosilyation catalyst;
an organopolysiloxane resin;
a silver-containing antimicrobial agent; and
a hydrophilic compound,
wherein the composition is an emulsion that has a continuous phase and a discontinuous phase.

2. The composition of claim 1, wherein the composition comprises 0.5 wt % or more of the organopolysiloxane resin, based on the total weight of the composition.

3. The composition of claim 1, wherein the organopolysiloxane resin comprises M and Q units.

4. The composition of claim 1, wherein the curable composition does not exhibit an observable phase separation for at least 24 hours at 23° C. and a relative humidity of 55% or after being centrifuged at 23° C. and 5000 rpm for 5 minutes.

5. The composition of claim 1, wherein an interfacial tension between the continuous phase and the discontinuous phase is less than 28 mN/m.

6. The composition of claim 1, wherein the silver-containing antimicrobial agent is silver salt.

7. The composition of claim 1, wherein the hydrophillic compound is a polyol.

8. The composition of claim 1, wherein the curable composition has a continuous phase comprising an polysiloxane network.

9. The composition of claim 1, further comprising a hydrosilylation inhibitor.

10. The composition of claim 1, wherein the antimicrobial agent and the hydrophilic compound being present in the discontinuous phase.

11. The composition of claim 2, wherein the composition comprises 0.5 to 5 wt % of the organopolysiloxane resin, based on the total weight of the composition.

12. The composition of claim 4, wherein the curable composition does not exhibit an observable phase separation after 90 days at 23° C. and a relative humidity of 55% or after being centrifuged at 23° C. and 5000 rpm for 5 minutes.

13. The composition of claim 5, wherein the interfacial tension between the continuous phase and the discontinuous phase is 22 to 28 mN/m.

14. The composition of claim 7, wherein the polyol is glycerol.

15. The composition of claim 7, wherein the hydrophilic compound is polyhydric alcohol or a polyether.

16. A method of forming a gel adhesive, comprising:
applying a composition according to claim 1 to a substrate; and
curing the composition.
